(19) United States
(12) Patent Application Publication
(10) Pub. No.: US 2017/0293872 A1
(43) Pub. Date: Oct. 12, 2017

(54) Systems and Methods for Enabling Multiple Management Activities for Business Entities Through Domain Models

(71) Applicant: MASTERCARD INTERNATIONAL INCORPORATED, Purchase, NY (US)

(72) Inventors: Gary VonderHaar, Wildwood, MO (US); Mary B. Griffin, Defiance, MO (US); Antonio N. Ferri, Southlake, TX (US); Vijayanath Bhuvanagiri, Wildwood, MO (US); David Lillis, St. Louis, MO (US)

(21) Appl. No.: 15/247,100

(22) Filed: Aug. 25, 2016

Related U.S. Application Data
(60) Provisional application No. 62/320,050, filed on Apr. 8, 2016.

(51) Int. Cl. G06Q 10/06

(52) U.S. Cl. CPC G06Q 10/067; G06Q 10/0637

(57) ABSTRACT

Systems and methods for use in enabling multiple management activities for a business entity through a domain model are disclosed. One exemplary method includes receiving, in response to a user input, a change to a domain model. The domain model is representative of technology associated with a business entity, and the domain model defines multiple layers, each associated with one of infrastructure, a plurality of services, and/or a plurality of business products of the business entity. Each layer includes multiple assets. And, the domain model further defines at least one relationship between one of the multiple assets in one layer and at least one of the multiple assets in a different layer. The method further includes updating the domain model based on the change and exposing the updated domain model to multiple different management activities of the business entity.

### CROSS-REFERENCE TO RELATED APPLICATION

This application claims the benefit of, and priority to, U.S. Provisional Application No. 62/320,050 filed on Apr. 8, 2016. The entire disclosure of the above application is incorporated herein by reference.

### FIELD

The present disclosure generally relates to systems and methods for use in enabling multiple management activities for business entities through domain models, and in particular, to systems and methods for use in executing management activities, which are reliant on domain models that are updated consistent with business and/or technology strategies of the business entities.

### BACKGROUND

This section provides background information related to the present disclosure which is not necessarily prior art.

Payment networks are known to facilitate payment account transactions between consumers and merchants. In doing so, the payment networks provide a variety of services to entities potentially involved in the transactions, such as banking institutions (e.g., issuers, acquirers, etc.), etc. The payment networks maintain physical infrastructures, which enable the payment networks to provide such services across multiple geographic regions. When changes are made to aspects of the infrastructures, or to the services offered there through, the payment networks manage the changes to ensure interruptions to other services are avoided. Separately, a variety of different software products are known, which permit business entities to inventory certain parts of their technology to support specific functions, such as software development or financial analysis. Example software products include lifecycle management software, by Rally Software Development Corporation, and financial management software, by Apptio, Inc. Generally, these software products operate independently on inventories of the business entities.

### DRAWINGS

The drawings described herein are for illustrative purposes only of selected embodiments and not all possible implementations, and are not intended to limit the scope of the present disclosure.

FIG. 1 illustrates an exemplary system suitable for use in enabling multiple management activities for business entities through domain models, and including one or more aspects of the present disclosure;

FIG. 2 is a block diagram of an exemplary computing device, suitable for use in the system of FIG. 1;

FIG. 3A illustrates an exemplary domain model for a business entity, which can be stored in tangible form in the system of FIG. 1, for use as described herein;

FIG. 3B illustrates a detailed view of the domain model of FIG. 3A;

FIG. 4 is a flowchart of an exemplary method, which can be implemented via the system of FIG. 1, for enabling multiple management activities for business entities through domain models;

FIGS. 5-6 illustrate exemplary interfaces representative of a domain model, suitable for use with the system of FIG. 1 and/or the method of FIG. 4; and

FIGS. 7-9 illustrate exemplary interfaces representative of a financial management activity accessing a domain model, suitable for use in the system of FIG. 1 and/or the method of FIG. 4.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment networks, and other business entities, manage technology to promote efficient operation and quality of services to their clients (e.g., to persons, consumers, other business entities, etc.). Depending on the type of business entity, the technology, when implemented into multiple different products, becomes increasingly difficult to manage, to ensure, for example, efficient implementation, cost management, and/or efficiency failure/trouble handling. Uniquely, the systems and methods herein provide a common domain model, which is representative of the technology of a business entity (e.g., a payment network, etc.) and, mainly, of assets of the business entity structured in different layers. Changes to the domain model are then controlled, through the systems and methods, and the domain model is exposed to various business management activities, such as, for example, financial management, software lifecycle management, etc. In this manner, the business management activities are reliant on the common domain model of the business entity's assets to operate, thereby accomplishing the management activities more efficiently, drawn from the common domain model, as compared to maintaining different inventories of the business entity's assets for each of multiple different management activities.

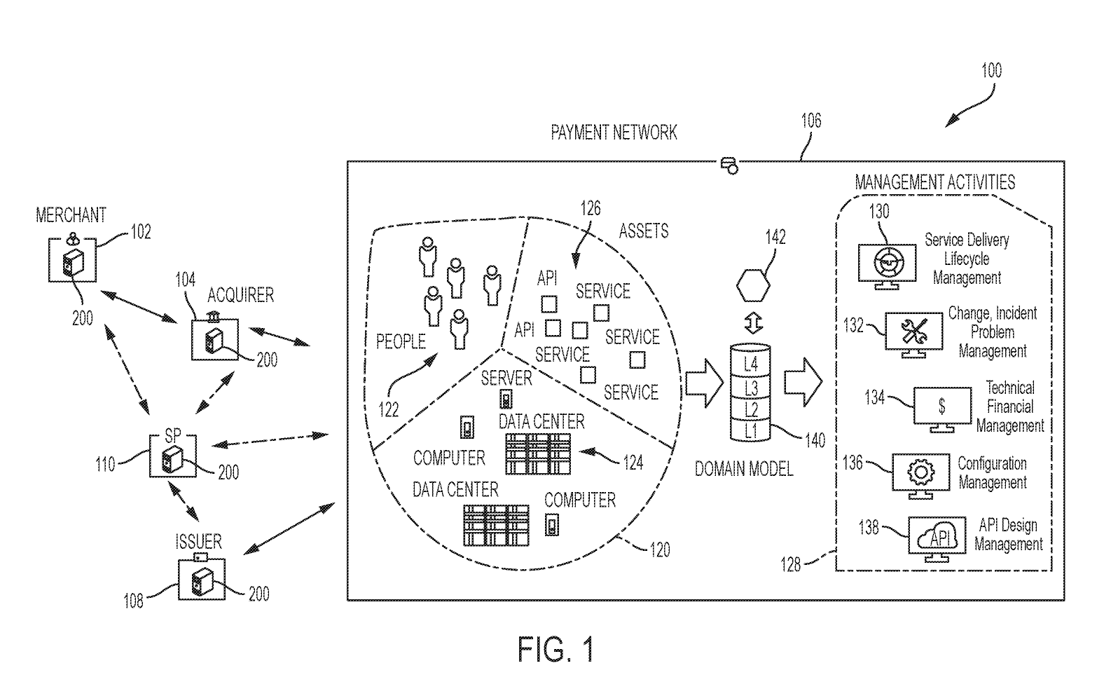

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, types of business entities and/or management activities involved, offerings of products and/or support, etc.

As shown in FIG. 1, the illustrated system 100 generally includes a merchant 102, an acquirer 104, a payment network 106 (broadly, a business entity herein), and an issuer 108, each coupled to one or more networks. Regardless of the arrangement of the one or more networks, or even the number of networks in the system 100, network connections are indicated in FIG. 1 by arrowed lines between the various particular parts of the system 100. The networks may include, without limitation, wired and/or wireless networks, local area networks (LANs), wide area networks (WANs) (e.g., the Internet, etc.), mobile networks, and/or other suitable public and/or private networks capable of supporting communication among two or more of the illustrated parts of the system 100, or any combination thereof. In one example, one of the networks includes multiple networks, where different ones of the multiple networks are accessible to different ones of the illustrated parts in FIG. 1. In particular in this example, the acquirer 104, the payment network 106, and the issuer 108 may be connected via a private network for processing payment transactions (or offering further products), and the merchant 102 and/or one or more consumers may be connected with the payment network 106, for example, through a public network, such as the Internet.

It should be appreciated that while the present disclosure is provided with reference to a payment network and payment transactions facilitated by the payment network, the description herein is not so limited and may be applicable to other different types of networks and/or business entities, related or unrelated to payment networks and payment transactions.

In the illustrated system 100, the merchant 102 provides commodities and/or services, etc., at physical store-front locations (e.g., brick-and-mortar stores, etc.) and/or through virtual store-front locations (e.g., network-based applications, etc.). A consumer often purchases the commodities and/or services, etc. from the merchant 102 through a transaction, which may be funded by cash, check, payment account, etc. As an example, when the consumer intends to make a purchase at the merchant 102, funded by a payment account issued by issuer 108, the consumer presents a payment device (e.g., a credit card, debit card, fob, virtual wallet, etc.) to the merchant 102, and in particular, to a point of sale (POS) terminal (not shown) of the merchant 102. In turn, the merchant 102 reads payment account information from the payment device. The merchant 102 then submits an authorization request to the acquirer 104 (associated with the merchant 102) for processing the transaction.

In response, the acquirer 104 communicates the authorization request with the issuer 108 (associated with the consumer's payment account), through the payment network 106, such as, for example, through MasterCard®, VISA®, Discover®, American Express®, etc. The issuer 108 generally determines whether the consumer's payment account is in good standing and whether there are/is sufficient funds and/or credit to fund the transaction. If the transaction is approved, an authorization reply, or response (indicating the approval of the transaction), is transmitted back from the issuer 108 to the merchant 102, thereby permitting the merchant 102 to complete the transaction. The transaction is later cleared and/or settled (via appropriate transaction messages such as clearing messages and/or settlement messages, for example) by and between the merchant 102, the acquirer 104, and the issuer 108 (by appropriate agreements). If the transaction is declined, however, an authorization reply (indicating the decline of the transaction) is provided back to the merchant 102, thereby permitting the merchant 102 to halt or terminate the transaction, or request alternate funding.

In addition, the system 100 includes a service provider 110, which is coupled to (and is in communication with) the merchant 102, the acquirer 104, the payment network 106, and/or the issuer 108, via one or more networks (as described above). The manner in which the service provider 110 is coupled often depends on the type of service provided thereby. For example, when the service provider 110 is configured as a merchant plug-in (MPI) and/or access control server (ACS), for enhanced authentication services, the service provider 110 may be coupled to the merchant 102 and/or the issuer 108, etc. In another example, when the service provider 110 is configured to provide, in whole or in part, a virtual wallet application, the service provider 110 may be coupled to the issuer 108 and/or the payment network 106, to communicate therewith, for example, via one or more application program interfaces (APIs), in order to support the virtual wallet application. In yet another example, when the service provider 110 is configured to provide offers and/or loyalty rewards based on use of a payment account (and primary account number (PAN) associated therewith) issued by the issuer 108, the service provider 110 may again be coupled to the issuer 108 and/or the payment network 106, to communicate therewith, for example, again via one or more APIs, in order to provide the offers and/or loyalty rewards. It should be appreciated that a variety of different service providers may be included in the system 100, or other system embodiments, and/or may provide a variety of services associated with the payment network 106, or that rely, in whole or in part, on interactions with the payment network 106, etc.

In the illustrated system 100, transaction data is generated, collected, and stored as part of the above-described interactions among the consumers and the merchant 102, the acquirer 104, the payment network 106, the issuer 108, and/or the service provider 110. The transaction data represents at least a plurality of transactions, for example, authorized transactions, cleared and/or settled transactions, attempted transactions, etc. between consumers and the merchant 102. The transaction data, in this exemplary embodiment, is stored at least by the payment network 106 (e.g., in a data structure associated with the payment network 106, etc.). In other embodiments, the transaction data may be stored by other parts of the system 100 and transmitted between the parts of the system 100 as needed. As used herein, transaction data may include, for example (and without limitation), PANs for consumers involved in the transactions, amounts of the transactions, merchant IDs for merchants involved in the transactions, merchant category codes (MCCs), balances, payment history dates/times of the transactions/payments, incentives used (e.g., rebates discounts, etc.), etc. It should be appreciated that more or less information related to transactions, as part of either authorization or clearing and/or settling, may be included in transaction records and stored within the system 100, at the merchant 102, the acquirer 104, the payment network 106 and/or the issuer 108.

In various exemplary embodiments, consumers involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

While one merchant 102, one acquirer 104, one payment network 106, one issuer 108, and one service provider 110 are illustrated in FIG. 1, it should be appreciated that any number of these parts (and their associated components) may be included in the system 100, or may be included as parts of systems in other embodiments, consistent with the present disclosure.

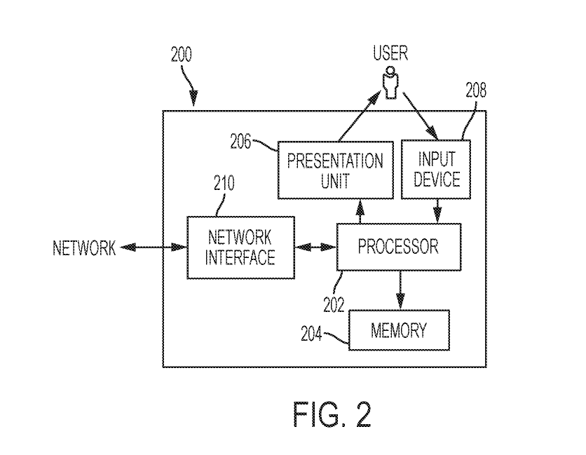

FIG. 2 illustrates an exemplary computing device 200 that can be used in the system 100. The computing device 200 may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchant 102, the acquirer 104, the issuer 108, and the service provider 110 are illustrated as including, or being implemented in, computing device 200. In addition, while not illustrated, the payment network 106 may also include, or be implemented in, one or more computing devices consistent with computing device 200. Further in the system 100, assets 120 and/or management activities 128 of the payment network 106, for example, as described below, may include computing devices, each consistent with computing device 200. With that said, the system 100 should not be considered to be limited to the computing device 200, as described below, as different computing devices and/or arrangements of computing devices may be used.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, domain models, asset profiles (e.g., data related to assets), APIs, services, interfaces, and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and in communication with) the processor 202 (however, it should be appreciated that the computing device 200 could include output devices other than the presentation unit 206, etc.). The presentation unit 206 outputs information, either visually or audibly to a user of the computing device 200, for example, a user associated with one or more parts of the system 100, etc. It should be further appreciated that various interfaces (e.g., representing a domain model, and/or associated with one or more management activities, etc.) may be displayed at computing device 200, and in particular at presentation unit 206, to display information, such as, for example, content of a domain model, selectable products of a business entity, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs). The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks in the system 100, for example. Further, in some exemplary embodiments, the computing device 200 includes the processor 202 and one or more network interfaces incorporated into or with the processor 202.

Referring again to FIG. 1, the payment network 106 includes a variety of different assets 120, which enable the payment network 106 to perform various operations, including operations related to purchase transactions, APIs, payment accounts (e.g., virtual wallets, rewards, etc.), and other products useable internally or externally to the payment network 106. As shown in FIG. 1, the assets 120 include, generally: people 122; computing devices 124 such as, for example, computers, desktops, laptops, tablets, serves, data centers, etc.; and platform services (e.g., service busses, message brokers, etc.) and software parts 126 in the form of services, APIs, etc. In the system 100, the assets 120 are generally associated with technology at the payment network 106. Other non-technology assets of the payment network 106, however, may exist but are not illustrated. Specifically, for example, persons supporting technology for human resources (HR) would be included in the assets 120 in the illustrated system 100, but the persons working in HR would not. It should be appreciated that the assets 120 illustrated in FIG. 1 are exemplary in nature and may be different in other embodiments. As such, different assets and/or types of assets may be included in other embodiments, whether involved with technology or not, and represented in a domain model depending, for example, on the type of business entity and/or the management activities reliant thereon, etc.

Each asset 120 of the payment network 106 is associated with an asset profile, or pertinent data about the asset (often dependent on the type of asset), such as, for example, a type of asset, a description of the asset (e.g., hardware description, functional description, input/output protocols, etc.), a location of the asset, persons associated with the asset (e.g., an owner or responsible person for the asset, etc.), the business affiliation of the asset (e.g., accounting, sales, authentication, etc.), dates associated with the asset (e.g., commission date, on-line date, revision dates, completion dates, etc.), status of the asset (e.g., deployed, in development, etc.), costing information associated with the asset, and decomposition of the asset to a predetermined level of granularity, etc.

The payment network 106 also includes the management activities 128, which are often employed by the payment network 106 to further its business, directly or indirectly. As shown, the management activities 128 include, for example, service delivery lifecycle management 130; change, incident, and problem management 132; technology financial management 134; configuration management 136; and API design management 138. Specifically, the service delivery lifecycle management 130 includes management of services (e.g., shared services and business services, etc.) within the payment network 106. Often, the service delivery lifecycle management 130 includes a computer-based platform (e.g., a software platform, etc.), through which one or more services are developed, deployed, revised, and/or maintained. The change, incident, and program management 132 includes a customer support services platform, through which customer support persons provide support to clients (e.g., to consumers, persons, other business entities, etc.). The technology financial management 134 includes a financial platform, through which the payment network 106 is able to provide a variety of financial functions and/or analyses, such as, for example, costing, etc. The configuration management 136 includes a platform through which the configuration of the technology of the payment network 106 may be reviewed and/or changed (e.g., reallocate storage capacity, add/remove a server of other computing capabilities (e.g., changes to a configuration management data structure, etc.), and/or reallocate computing capabilities among services, etc.). And, the API design management 138 includes a platform, through which the development, deployment, revision, and maintenance of APIs is managed and/or controlled.

It should be appreciated that the management activities 128 are depicted apart from the assets 120 only for purposes of illustration. Each is technology of the payment network 106. As such, for example, each of the activities 128 may include a computing device (e.g., consistent with computing device 200, etc.) that, in turn, is an asset 120. Further, each service included in the management activities 128 is also (or is also associated with) an asset 120.

The payment network 106 further includes a domain model 140 (broadly, a data structure) stored in memory (e.g., the memory 204, etc.). The domain model 140 is indicative of the assets 120 of the payment network 106 and the relationships among the assets 120, etc. The domain model 140 is stored in computer-readable media, which may include the memory 204, for example, and is also understood to be an asset 120 of the payment network 106.

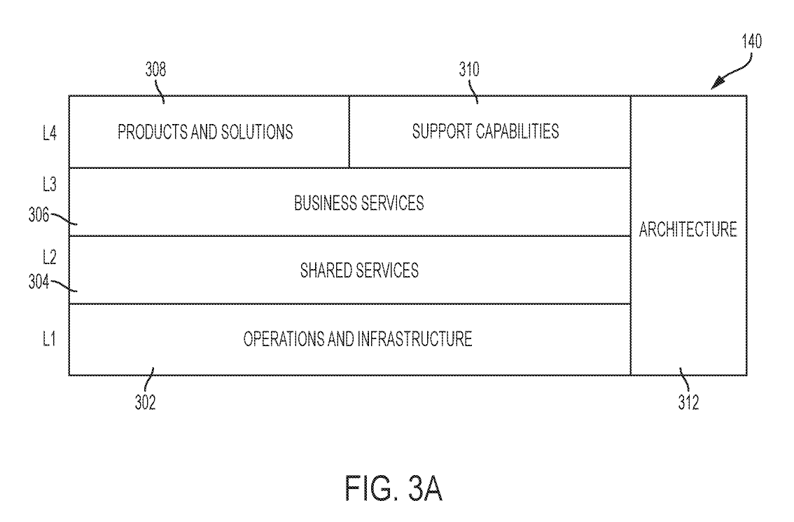

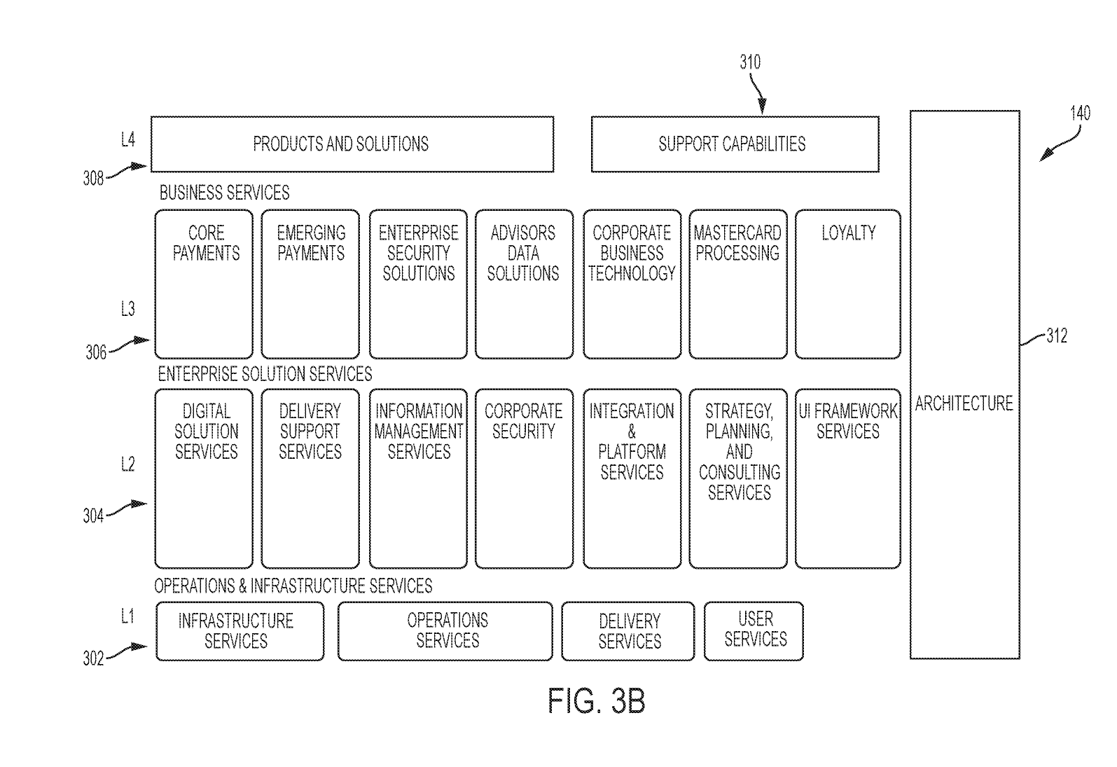

FIGS. 3A-3B provide an exemplary representation of the domain model 140. As shown in FIG. 3A, the domain model 140 generally includes four layers, referenced L1, L2, L3 and L4. The first layer L1 of the domain model 140 includes technology infrastructure 302 of the payment network 106 (i.e., operations and infrastructure in FIG. 3A), which provides the physical capabilities of the payment network 106 and includes, without limitation, the computers, data networks, databases, storage, IT operations, corporate IT, customer operations, and the person(s) assigned to support the physical technology, etc. The second layer L2 includes shared services 304, which include services of the payment network 106 that are shared by one or more other services. Shared services 304 include, for example, data warehouses, integration APIs, content management solutions, call center solution services, development services, information governance, corporate security (e.g., access management, security event management services, etc.), strategy, planning and consulting services (e.g., capacity planning), framework services (e.g., mobile framework, etc.), etc.

The third layer L3 of the domain model 140 includes business services 306, which include services of the payment network 106 that are related to business services. The business services 306 may include, for example, wallet services, loyalty services, authentication services, dispute resolution services, B2B services, transaction processing, and prepaid management services, etc. The business services are the automated part of the business capabilities, which are business functions internally and externally visible. And, the fourth layer L4 includes products and solutions 308 of the payment network 106 as well as the support services (i.e., support capabilities 310 in FIG. 3A). The business products and solutions 308 and the support capabilities 310 generally map to the business services 306 on the third layer L3. For example, the issuer 108 may offer a virtual wallet to its consumers, which is a product provided from the payment network 106 and accessible by accessing the wallet services in the third layer L3 of the domain model 140. The support capabilities 310 are generally internal to the payment network 106 and relate to, for example, sales, marketing, accounting, human resources, legal, etc.

More particularly, and as shown in FIG. 3B, in the first layer L1 of the domain model 140, the technology infrastructure 302 includes infrastructure services (e.g., computing services, data network services, storage services, database services, etc.), operations services (e.g., customer operations, IT operations, corporate security operations, etc.), delivery services (e.g., customer implementation services, etc.), and user services (e.g., corporate IT, etc.). In the second layer L2, the shared services 304 include digital solution services (e.g., content management solutions, consumer digital enablement solutions, call center solution services, etc.); delivery support services (e.g., development services, quality engineering, etc.); information management services (e.g., data delivery, information insight, information governance, etc.); corporate security (e.g., business alignment, engineering services, business continuity, physical security, security management services, access management services, etc.); integration and platform services (e.g., integration services, business process management services, enterprise decision management services, etc.); strategy, planning and consulting services (e.g., enterprise architecture practice, general consulting services, mergers and acquisitions, technology consulting, capacity planning, etc.); and UI framework services (e.g., rich mobile framework, etc.). And, in the third layer L3, the business services 306 include core payments (e.g., transaction switching, commercial services, etc.); emerging payments (e.g., personal payments services, bill pay services, checkout services, digital enablement services, developer zone services, payment gateway services, etc.); enterprise security solutions (e.g., authentication services, dispute resolution services, fraud solutions services, etc.); advisors data solutions (e.g., analytic services, etc.); corporate business technology (e.g., B2C services, B2B services, financial services, treasury services, fraud reporting services, financial management services, etc.); payment network processing (e.g., transaction processing services, prepaid management services, payment gateway services, etc.); and loyalty (e.g., rewards, offers, etc.).

With further reference to FIGS. 3A-3B, and as described above, the domain model 140, by the inclusion of the assets 120 (including the computing devices associated with the activities 128 and associated services), provides an inventory for the technology of the payment network 106. In addition, the domain model 140 includes an architecture 312, indicating dependencies (broadly, relationships) among the assets 120 included in the domain model 140. The relationships exist within the layers L1-L4 of the domain model 140 and among different ones of the layers L1-L4. Specifically, for example, a wallet service, in the business services 306 of layer L3 may utilize a login service and an offer service, each within the shared services 304 of layer L2. The wallet service may be present in a regional branch server, while the login and offer services run from a data center, which is apart from the regional branch server. Each of the regional branch server and the data center are included in the infrastructure 302 of layer L1. The architecture 312 of the domain model 140 draws the relationship among the services and computing devices, whereby upon selection of a service or a computing device (or a business product), it would be apparent to the user what assets 120 (or other assets) are related to the services, computing device, or product. It should be appreciated that each of the assets 120 included in the domain model 140 generally includes at least one dependency in the architecture 312.

With reference again to FIG. 1, the payment network 106 includes a compliance engine 142 associated with the domain model 140, and which is configured, often by computer-executable instructions, to manage changes to the domain model 140. The engine 142 is illustrated as a stand-alone device for purposes of this description, which is consistent with computing device 200, and is considered included in the assets 120 of the payment network 106.

The engine 142 is configured to update the domain model 140, in response to a blueprint, for which a permit has been issued by one or more users. In particular, the engine 142 is configured to determine whether a blueprint has been approved, whereby a permit has issued for the blueprint, and to update the domain model 140 consistent with the blueprint when the permit is issued. The update may include appending, removing or revising the assets 120, and appending, removing, or revising dependencies associated with the same or different assets 120. The engine 142 is further configured to expose the domain model 140 to multiple management activities 128 of the payment network 106. In this manner, the management activities 128 are able to rely on the domain model 140 to accomplish operations specific thereto.

As described above, business entities may include different assets and/or types of assets in other embodiments, whether involved with technology or not, and represented in domain models depending, for example, on the type of the business entities and/or the management activities reliant thereon, etc. In particular, in some embodiments, for example, systems may include assets for business entities comprising only human resources (e.g., a workforce, etc.), and may exclude other types of assets (such as computer assets, infrastructure, etc.). The systems may then also include domain models and management activities consistent with the above, whereby the human resources may be directed and/or allocated consistent with business strategies, technology strategies, etc., as appropriate. In other embodiments, for example, systems may exclude human resources for business entities and focus exclusively on other assets, or include combinations thereof.

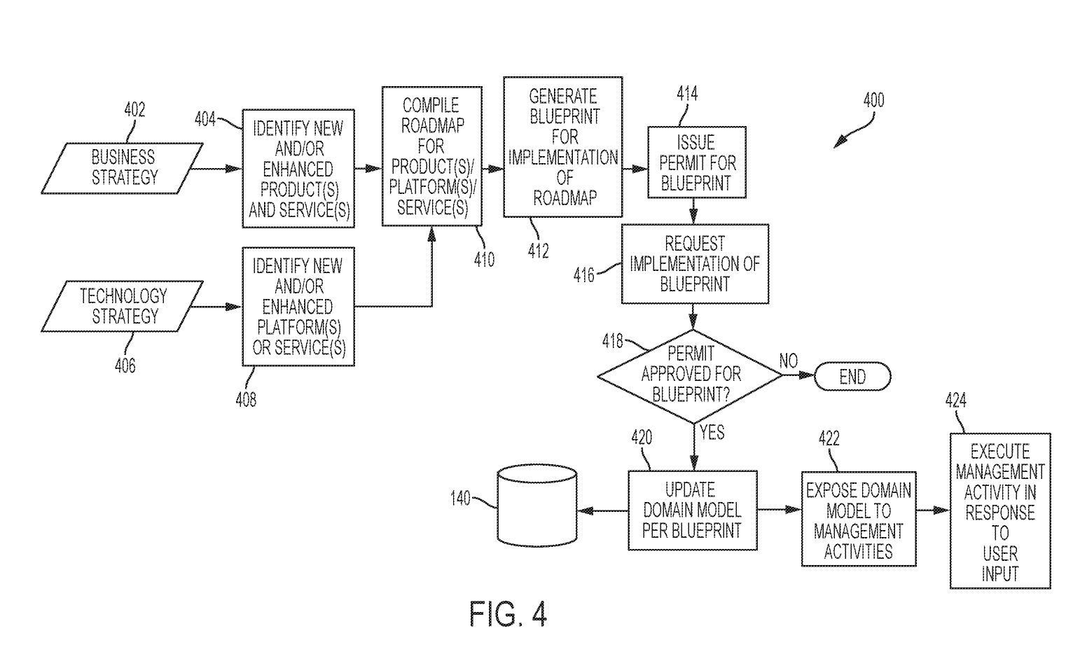

FIG. 4 illustrates an exemplary method 400 for use in enabling multiple management activities for business entities through domain models, and maintaining domain model data structures for the business entities. The exemplary method 400 is described as implemented in the payment network 106 of the system 100 and, more particularly, in the domain model 140 and/or in the compliance engine 142 thereof. It should be understood, however, that the methods herein (including the method 400) are not limited to the exemplary system 100 or the exemplary computing device 200 Likewise, the systems and the computing devices herein should not be understood to be limited to the exemplary method 400. In addition, while the method 400 is described with reference to the payment network 106, the methods described herein are applicable to a variety of business entities (other than the payment network 106). Generally, the systems and methods herein may include any different type of business entity in which assets, whether related to technology or otherwise, are deployed by the business entity and relevant to multiple business management activities of the entity, etc.

With reference to FIG. 4, occasionally in the method 400, business strategies may dictate offering new and/or enhanced products or services, at 402, from the payment network 106, which may, for example, address voids in current product offerings of the payment network 106, improve the products of the payment network 106, aid the payment network 106 in expanding into new businesses, or address various other business oriented causes/reasons, etc. From the business strategies, the payment network 106, and in particular, one or more users (not shown) associated therewith, identifies the new or enhanced products and/or services, at 404.

Similarly, occasionally, technology strategies may dictate the addition and/or improvement of the technology of the payment network 106, at 406, for various reasons, such as, for example, improving performance, improving customer experience, expansion of certain products or services, increasing demand, replacement of outdated and/or underperforming assets 120, etc. From the technology strategies, the payment network 106, and in particular, one or more users associated therewith, identifies new or enhanced platforms and/or services, at 408. Generally, the users involved in identifying new or enhanced products, services and/or platforms are subject matter specific. For example, technology users typically identify new or enhanced services or platforms for the technology strategies, at 408, while business users (e.g., users in marketing or sales, customer liaisons, etc.) identify new or enhanced products or services for the business strategies, at 404.

Once identified, the new or enhanced products, platforms, and/or services (broadly referred to, collectively, as “products”) are advanced to a planning aspect of the payment network 106, and in particular, an architect, technical lead, a group of architects and/or multiple technical leads, etc. (broadly, one or more users or a committee), to determine how to implement the products. In connection therewith, the committee compiles, at 410, a roadmap that defines the implementation of the products. This may include, for example, identifying a segregation of functions of the products into different services, identification of the types of services, the placement of the products, identifying the hardware necessary to support the products, etc. The roadmap is generally a description of the products in terms of the technology integral in offering the products, and is stored in memory such as an architecture repository, (e.g., memory 204, etc.) once identified.

Subsequently, when the roadmap is complete, a blueprint for implementation of the roadmap is generated, at 412, often by one or more different users. The users may be the same as those included in the compilation of the roadmap (described above), and/or different. As part of generating the blueprint, the users interact with the engine 142, which provides the users with access to the domain model 140.

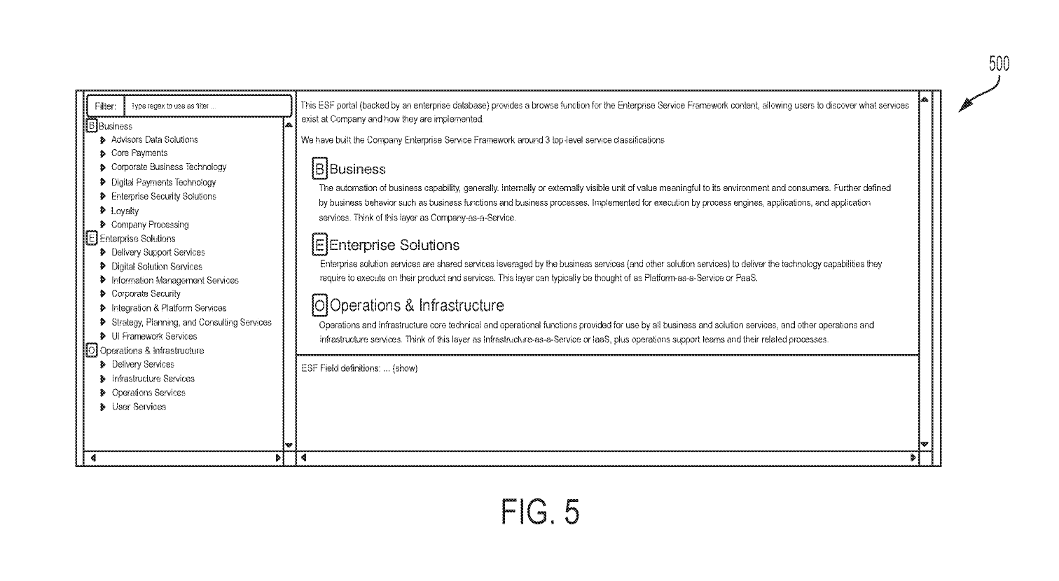

FIG. 5 illustrates an exemplary interface 500, which includes content representative of the domain model 140 for the payment network 106, and through which users are able to access the domain model 140. As shown in FIG. 5, the domain model 140, as described above with reference to FIGS. 3A-3B, is represented in multiple layers, which are titled, in the interface 500, as “Business” (corresponding to the business services layer L3 in FIG. 3A), “Enterprise Solutions” (corresponding to the shared services layer L2 in FIG. 3A), and “Operations & Infrastructure” (corresponding to the infrastructure layer L1 in FIG. 3A). Each of the layers of the domain model 140 in FIG. 5 is expandable, as shown along the left portion of the interface 500, to reveal a tree of assets 120 and/or asset categories thereunder. For example, the Business layer includes Core Payments services and Loyalty services, among others, while the Enterprise Solutions layer includes Digital Solution Services and Information Management Services, among others. It should be understood that as assets 120 and/or asset categories are selected/expanded, additional and/or different content related to the assets 120 and/or asset categories thereunder become visible, thereby permitting the users to “drilldown” to different assets 120 in different layers of the domain model 140.

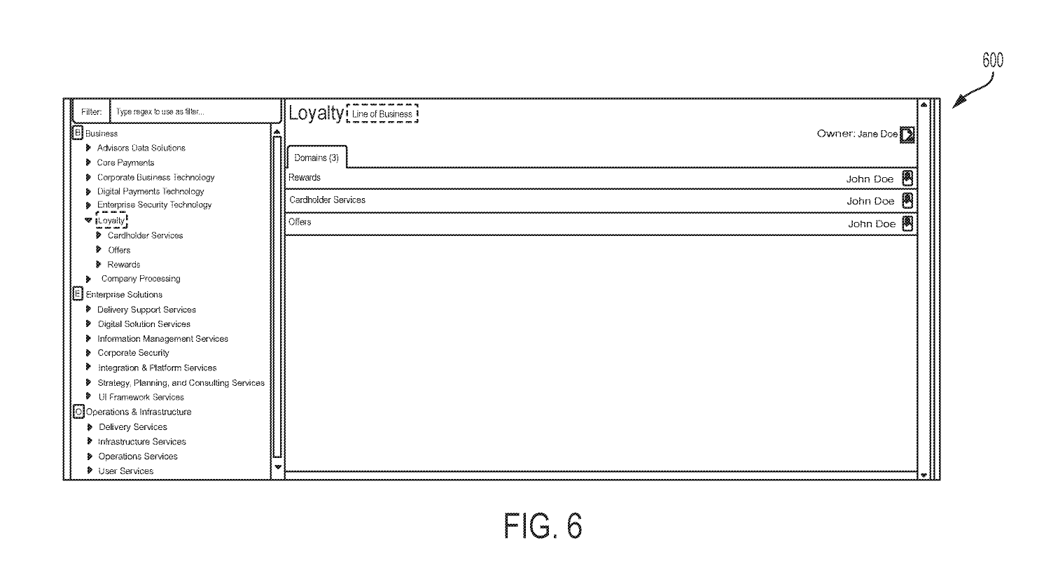

FIG. 6 illustrates an exemplary interface 600 that may be displayed to a user following selection (e.g., a user input, etc.) of the “Loyalty” option under the Business layer in the interface 500 of FIG. 5 (in the expanded tree along the left portion of the interface 500). The interface 600 includes additional content representing the domain model 140, in response to the user input, i.e., the user's selection of the Loyalty service in the Business layer. As shown, the Loyalty service includes three sub-services (i.e., assets 120) thereunder: Rewards, Cardholder Services, and Offers. In addition, the interface 600 indicates that Jane Doe is the owner of the Loyalty services, and that John Doe is the owner of each of the sub-services within the Loyalty services. It should be appreciated that the user is able to further “drilldown” into the interface 600, as desired or required, to determine what assets 120 are included in the domain model 140 of the payment network 106, for example, in the sub-services, and where in the domain model 140 the assets 120 are present. Further, the user is able to identify and/or understand the detailed architecture in the architecture repository of the domain model 140.

Referring again to FIG. 4, upon generation of the blueprint, one or more users review the blueprint and issue, at 414, a permit for the blueprint to be implemented into the domain model 140. The permit may be issued for the blueprint, based on one or more different criteria (e.g., procedures, tests, checks, etc.), etc., whereby the appropriate persons/users within the payment network 106 approve/confirm the blueprint, etc. The criteria may include, for example, confirmation that assets are being used and/or reused across multiple management activities 128 of the payment network 106 (as compared to creating new assets or redundant assets for use), etc. As indicated above, the blueprint can be initiated from either a business strategy decision, at 402, or a technology strategy decision, at 406. In connection therewith, the review related to issuing the permit includes a validation by one or more users (e.g., architects, etc.), for example, of the blueprint against the corresponding strategy to ensure the blueprint is consistent therewith.

Once the permit is issued, one or more users request, at 416, to implement the blueprint into the domain model 140. In turn, the engine 142 determines, at 418, whether a permit has been issued for the blueprint (and whether the permit is associated with the blueprint). If one has not been issued (or the permit is not associated with the blueprint), the engine 142 declines the update and ends the process (at least until a new request is sent with the proper permit). Conversely, if a permit has been issued, the engine 142 updates, at 420, the domain model 140 consistent with the blueprint. Updating the domain model 140 may include, for example, appending and/or removing assets 120 to/from the domain model 140, altering the architecture to accommodate appended/removed assets 120, forming new relationships between existing assets 120, and/or reallocating assets 120 to different products, etc.

In addition in the method 400 (e.g., before and/or after updating (at 420), etc.), the engine 142 exposes, at 422, the domain model 140 to multiple business activities of the payment network 106. As such, in response to a user input, the multiple different management activities 128, illustrated in FIG. 1, for example, are executed, at 424, whereby the management activities 128 are able to retrieve and/or access the content of the domain model 140, in whole or in part, to perform their intended functions and/or operations. As a result, the domain model 140, as changed/updated, may affect the various functions and/or operations of the business activities/management activities reliant on the domain model 140.

As an example, the technology financial management 134 (in the activities 128 of the payment network 106) may be executed, in response to an input by a user, to generate a cost associated with a product, which is offered by the payment network 106. The example product relies on the “offers” service of the payment network 106. As such, the user executes the technology financial management activity, which may include executing software related to the same. In response, interfaces are displayed to the user, at a computing device (e.g., computing device 200), through which the user is able to generate cost for the example product.

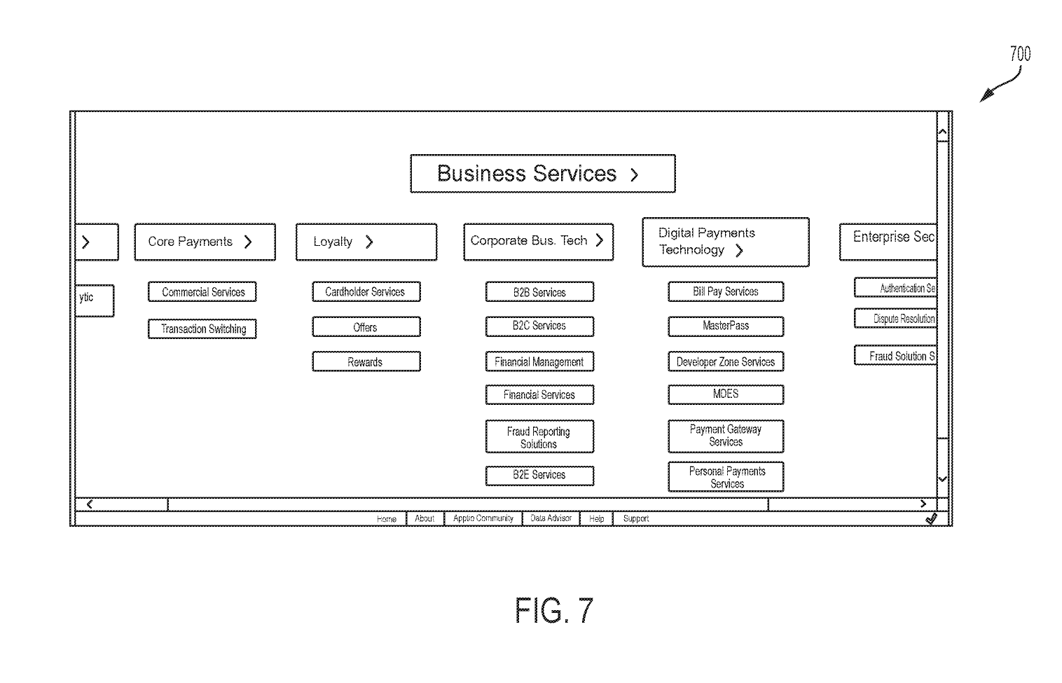

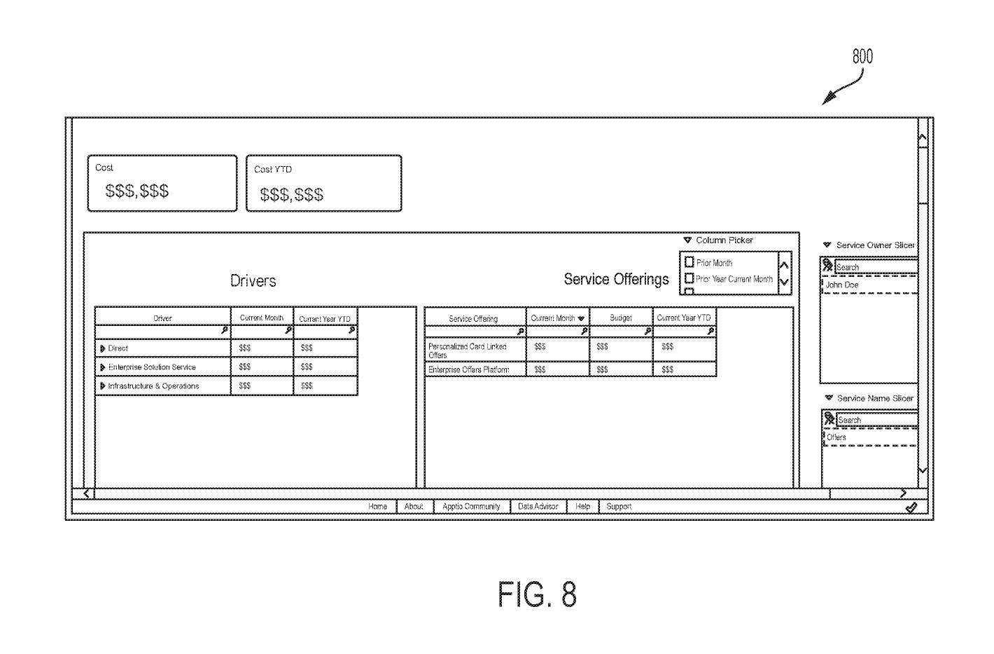

In connection with this example, FIG. 7 illustrates an exemplary interface 700, which is representative of the domain model 140. The interface 700 permits the user to select the “offers” service in the business services layer (e.g., layer L3 in FIGS. 3A-3B, etc.) of the domain model 140, and to further select sub-services, etc., depending on the object of the user executing the financial management activity. In this example, the user selects the “offers” service, for example, under the loyalty service. In turn, FIG. 8 illustrates an interface 800, which is displayed to the user in response to the selection of the “offers” service. The interface 800 includes the cost associated with the “offers” service, not only at the business services layer, but also at the shared services layer (e.g., layer L2 in FIGS. 3A-3B, etc.) and the infrastructure layer (e.g., layer L1 in FIGS. 3A-3B, etc.). It is able to do so because access to the domain model 140, and specifically, the architecture therein (e.g., architecture 312 in FIGS. 3A-3B, etc.), permits the technology financial management activity to account for all related assets and costs for the same.

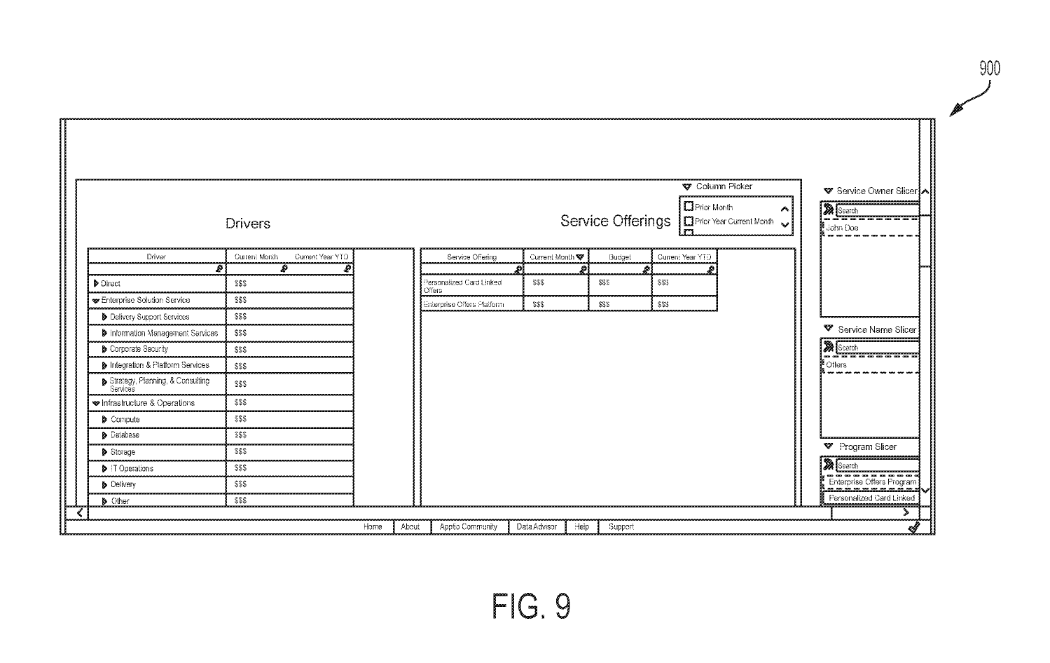

FIG. 9 illustrates an interface 900, in which different layers of the domain model 140, from FIG. 8, are expanded to show costs per asset of the “offers” service. As shown in FIG. 9, the interface 900 includes drivers and service offerings. The service offerings are the technology service assets (e.g., with the costs representing total costs of ownership for each business/enterprise service, etc.), and drivers are the cost drivers that affect the costs of the service offerings (e.g., thereby representing alignment of directly attributed costs and consumption of services managed elsewhere in the domain model 140 (e.g., at the operations and infrastructure layer, etc.), etc.). In connection with the drivers, for example, the interface 900 indicates that the cost associated with a Storage asset for the “offers” service (as part of the “Infrastructure & Operations”) is “$$$,” and the cost associated with a Corporate Security asset for the “offers” service (as part of the “Enterprise Solution Service”) is “$$$.” Similar costs are provided for the service offerings.

In another example, when configuration management 136 (in the activities 128 of the payment network 106) determines that a specific server is to be replaced and/or has been damaged or failed, the configuration management 136 is able to inform the change, incident, and problem management 132 (also in the activities 128 of the payment network 106), of the state of the specific server. In turn, by reference to the domain model 140, change, incident, and problem management 132 is able to identify the products and solutions 308 and/or the support capabilities 310 in the domain model 140 (e.g., customer onboarding, customer update, etc.), which rely on that server, so that any consumer complaints are able to be addressed more directly. It should be appreciated that, in some implementations, rather than inform change, incident, and problem management 132 of the specific server, configuration management 136, based on the domain model 140, may identify the affected products and solutions 308 and/or support capabilities 310 directly. In addition, it should be appreciated that change, incident, and problem management 132 may also identify products and solutions 308 and/or support capabilities 310 having issues, or which are the subject of numerous “tickets” for services and/or repair. The configuration management 136 may then, in turn, identify a specific server or other hardware, or businesses and/or shared services, based on the domain model 140, which are the root and/or cause the underlying issues and tickets.

Further, as tickets are generated for a fault in businesses and/or shared services, or for a fault in hardware, the change, incident, and problem management 132 reports the numbers of tickets generated, specific to the fault, to the financial management 134 (in the activities 128 of the payment network 106, as a management activity reliant on the domain model 140). As a result, the financial management 134 is able to assign and allocate the cost of the tickets to the particular businesses and/or shared services, or hardware. Again, based on the domain model 140, a complete (or substantially complete) picture of the costs associated with the assets 120 of the payment network 106 is able to be provided.

Moreover, even when a fault is not present in the assets 120, one or more particular products (within the products and solutions 308) may rely on specific shared services. However, interacting with such shared services can be cumbersome for consumers, thereby causing tickets (at the change, incident, problem management 132) to be opened at a greater frequency than for other products and solutions 308. The financial management 134, in turn, provides the costing information for the products, which would be elevated at the shared services (based on the domain model 140) for each of the particular products. The relative high rates of tickets (from change, incident, problem management 132) and/or the increased cost (from the financial management 134), then, are both tied to the specific shared services though the domain model 140, from which a technology strategy (e.g., at 406 in the method 400, etc.), for example, may define a change, improvement and/or revision to the shared services (and/or other assets 120 or relationships associated therewith).

As still another example, the lifecycle management 130 (in the activities 128 of the payment network 106) may be executed, for example, in response to a user input, to schedule pending development of new products (and in particular, one or more businesses and/or shared services, etc.). Once scheduled, the timeline of the development is appended to the product in the domain model 140, as appropriate. In addition to the scheduling, as the services are deployed in production, status markers and/or milestones are recorded in the domain model 140, along with cost information for the different milestones and/or the product (e.g., cost-to-date, cost per interval, etc.). The deployment of the products is also appended to the domain model 140, for example by indicating a status of “live” or “deployed” as part of the asset profiles for those assets associated and/or related to the products. In addition, a cost of use is then appended to the assets 120 of the domain model 140, which in some implementations results in the reduction of cost per asset, when the asset is spread to an additional product (i.e., the cost per use is less). Once the deployment is reflected in the domain model 140, the architecture change may cause the asset profiles associated with the products to be updated and/or revised according to usage of the products, etc. Further, the domain model 140 makes the new products and/or revisions to the products available to the other business management activities 128.

In yet another example, the service life cycle management 130 may result in changes to the configuration management 136. For example, the financial management 134 may use a cost of creating an asset 120 (e.g., a new business service, etc.) provided from the service lifecycle management 130 and further use the hardware configuration of the same asset 120 from the configuration management 136 to compute the cost and further to properly align the consuming business/shared services.

In view of the above, the systems and methods herein permit a domain model to be accessed by multiple different business management activities. The domain model defines, for example, the technology of a business entity, whereby changes to the technology, which are driven from a business strategy and/or a technology strategy, may be accounted. When changes are requested, a process is implemented, prior to implementation, to inhibit changes from diverging from the business and/or technology strategies. Once changes are made, the domain model, and in particular, the assets represented thereby, is subject to various interactions from business management activities, which are able to rely on the domain model as a source of data to perform their intended functions and/or operations. When the domain model is changed, by one or more of the business management activities, the other business management activities are able to rely on that change, in the domain model, as a single repository, without having to understand and account for the change in the domain model. As such, the present disclosure provides for an efficient representation of an aspect of a business entity (e.g., technology, etc.), which is, in turn, provided to enable multiple different management activities, thereby reducing any need for each management activity to independently model the aspect of the business entity.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) receiving, in response to a user input, a change to a domain model, wherein: (i) the domain model is representative of technology associated with a business entity; (ii) the domain model defines multiple layers, each of the multiple layers associated with one of infrastructure, a plurality of services, and/or a plurality of business products of the business entity; and (iii) each layer of the domain model includes multiple assets, the domain model further defining at least one relationship between one of the multiple assets in one layer and at least one of the multiple assets in a different layer; (b) updating the domain model based on the change; and (c) exposing the updated domain model to multiple different management activities of the business entity, whereby each of the multiple different management activities is able to account for the change, in one or more operations of the management activities, through the domain model.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” “included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in enabling multiple management activities for a business entity through a domain model, the method comprising:
receiving, by a computing device, in response to a user input, a change to a domain model, wherein:
the domain model is representative of technology associated with a business entity;
the domain model defines multiple layers, each of the multiple layers associated with one of infrastructure, a plurality of services, and a plurality of business products of the business entity; and
each layer of the domain model includes multiple assets, the domain model further defining at least one relationship between one of the multiple assets in one layer and at least one of the multiple assets in a different layer;
updating, by the computing device, the domain model based on the change; and
exposing, by the computing device, the updated domain model to multiple different management activities of the business entity, whereby each of the multiple different management activities is able to account for the change, in one or more operations of the management activities, through the domain model.

2. The computer-implemented method of claim 1, wherein the change includes a new service asset associated with at least one product; and
wherein updating the domain model based on the change includes appending at least one asset to one of the multiple layers of the domain model and defining at least one relationship, in the domain model, between the new service asset and one of the plurality of business products.

3. The computer-implemented method of claim 2, wherein one of the multiple management activities includes technology financial management; and
further comprising generating, by a computing device associated with the technology financial management activity, a cost associated with the one of the plurality of business products, including the at least one new service asset, based on the domain model.

4. The computer-implemented method of claim 3, wherein the business entity includes a payment network.

5. The computer-implemented method of claim 1, wherein the change is defined by a blueprint, and wherein the change includes a new relationship between a new asset and one of multiple assets; and
further comprising:
issuing a permit for the blueprint when a validation criteria is satisfied;
updating, by the computing device, the domain model based on the change, when the permit is issued for the blueprint; and
declining, by the computing device, to update the domain model based on the change when no permit is issued for the blueprint.

6. The computer-implemented method of claim 1, wherein the multiple layers include an infrastructure layer, a shared services layer and a business services layer; and
wherein updating the domain model includes defining relationships between ones of the multiple assets in the shared services layer and at least two assets in the business services layer.

7. A system for enabling multiple management activities for a business entity through a domain model, the system comprising:
a memory including a data structure having a domain model associated with technology for a payment network, wherein:
the domain model represents multiple technology assets of the payment network organized into multiple layers; and
the domain model defines an architecture among the multiple technology assets;
a domain model processor coupled to the memory and configured to:
receive a blueprint defining at least one change to the domain model; and
update the domain model to include the at least one change, when a permit is associated with the blueprint;
a first processor coupled to the memory and configured to execute a first management activity, which relies on the domain model; and
a second processor coupled to the memory and configured to execute a second management activity, which relies on the domain model, whereby updates to the domain model are disseminated to the first and second management activities.

8. The system of claim 7, wherein the multiple layers include at least three layers, one of the at least three layers including shared services.

9. The system of claim 7, wherein the architecture defines dependencies between each of the multiple assets and one or more other assets; and
wherein the first processor is configured to execute the first management activity for a product of the payment network selected by a user, whereby execution of the first business activity includes access to each asset in the domain model, which is associated with the selected product, as defined by the architecture included in the domain model.

10. The system of claim 9, wherein the first processor is configured, when executing the first management activity, to generate a cost of the product based on cost data associated with each asset associated with the selected product.

11. The system of claim 7, further comprising a third processor coupled to the memory and configured to execute a third management activity based on the domain model;
wherein the first management activity is related to financial management, the second management activity is related to lifecycle management, and the third management activity is related to incident/problem management.

12. The system of claim 7, wherein the domain model processor is further configured to determine whether the permit is associated with the blueprint and to decline update of the domain model when the permit is not associated with the blueprint.

13. The system of claim 7, wherein a single processor includes at least the domain model processor and the first processor.

14. The system of claim 7, wherein the domain processor is configured to cause at least one interface including content representative of the domain model to display to a user, in response to a user input.

15. The system of claim 7, wherein the multiple assets include at least services, people, and computing devices.

16. A system for enabling multiple management activities for a business entity through a domain model, the system comprising:
a memory including a data structure having a domain model associated with technology for a business entity, the domain model representative of multiple technology assets of the business entity organized into multiple layers and defining an architecture among the multiple technology assets; and
a domain model processor coupled to the memory and configured to:
receive a blueprint defining at least one change to the domain model;
update the domain model based on the at least one change when the blueprint is associated with a permit; and
expose the domain model to multiple different management activities of the business entity, whereby each of the multiple management activities are able to account for the at least one change, in one or more operations and/or functions of the management activities, based on reference to the domain model.

17. The system of claim 16, wherein the domain model includes each of the multiple technology assets arranged in multiple layers.

18. The system of claim 16, wherein the domain model is configured to decline to update the domain model when the blueprint is not associated with a permit.

19. The system of claim 16, wherein the at least one change includes a change to one of the multiple technology assets and/or the architecture, thereby affecting operations and/or functions of one or more of the multiple different business activities reliant on the one of the multiple technology assets and/or the architecture.

20. The system of claim 16, wherein the domain model processor is configured to display, via an interface, a relationship, as defined by the architecture, between one of the multiple technology assets and a business product or solution.
